(19) United States
(12) Patent Application Publication
(10) Pub. No.: US 2024/0188201 A1
(43) Pub. Date: Jun. 6, 2024

(54) FIELD ADJUSTABLE OUTPUT FOR DIMMABLE LUMINAIRES

(71) Applicant: EXPRESS IMAGING SYSTEMS, LLC, Renton, WA (US)

(72) Inventor: William G. Reed, Seattle, WA (US)

(21) Appl. No.: 18/370,304

(22) Filed: Sep. 19, 2023

Related U.S. Application Data
(60) Provisional application No. 63/429,675, filed on Dec. 2, 2022.

(51) Int. Cl. H05B 45/14

(52) U.S. Cl. CPC H05B 45/14

(57) ABSTRACT

A field adjustable output control usable with a luminaire to adjust dimming includes a plurality of voltage reference integrated circuits, each of the voltage reference integrated circuits having a respective associated voltage drop thereacross; and at least one switch operable to selectively adjust a total number of the plurality of voltage reference integrated circuits electrically coupled in series with one another between an LED driver dimming line and a ground to regulate a flow of current from the LED driver dimming line to a summed voltage that is equal to a sum of voltages respective associated voltage drops across the voltage reference integrated circuits that are electrically coupled in series with one another between the LED driver dimming line and the ground by the at least one switch.

### FIELD

The present application is directed to articles, apparatus and methods to adjust an output light level of a dimmable luminaire, for example a dimmable luminaire that employs light emitting diodes (LEDs).

### BACKGROUND

### Description of the Related Art

Modern luminaires for area, street or indoor lighting have circuitry which allows the light output of the luminaire to be reduced from a maximum light level to a lower light level, typically using a “0 to 10 volt” control line which is commonly referred to as a dimming line. The dimming line is a current source with a compliance of 0 to 10 volts DC. If a current sink, for example a resistor that connects the dimming line to ground, conducts current from the dimming line to ground, the voltage across the dimming line decreases from an unloaded voltage of 10 volts to some lower voltage. A light output of the luminaire dims in proportion to the lower voltage of the dimming line. In solid-state light luminaires (e.g., light emitting diode (LED) luminaires), the solid-state light sources (e.g., LEDs) are powered by an LED driver which may have a dimming line input. The LED driver provides a source current for the dimming line and limits a maximum voltage of the dimming line to approximately 10 volts DC. The value of the current sourced (I_{dim}) is determined by a design and manufacture of the specific LED driver and is typically not a programmable settable current.

A sampling of LED drivers demonstrates not only a wide range of dimming line source current values between different LED drivers, but also a wide range even within a single LED driver model from some manufacturers. For example, the data sheet for the Inventronics EUM-100SxxxLx series shows a range of 200 microamperes to 450 microamperes for the source current of the dimming line. Using a fixed value resistor to dim these widely varying dimming lines is impractical because of this wide range of dimming line source current values. To do so, a unique resistor value would need to be chosen for each luminaire to achieve the desired dimming value, which is clearly impractical when manufacturing hundreds of thousand luminaires per year. Notably, the applicable ANSI standard (ANSI C137.1-2019) provides voltage values for dimming but not source current value ranges.

A Field Adjustable Output (FAO) module is typically a printed circuit board with a rotary switch and resistors which are switched in to select the approximate current load for the desired dimming levels per switch position. A typical example of this is the SIGNIFY FAWS (Field Adjustable Wattage Switch). The FAWS can only practically be used with LED drivers having a tightly controlled and specific value source current on the dimming line. Use with other LED drivers will possibly result in widely incorrect dimming settings. Thus, the resistors values must be chosen for the specific LED driver model or manufacturer due to the relatively large and inconsistent variation in dimming line source currents between different LED drivers.

An approach that accommodates a wide variety of LED drivers is desirable.

### BRIEF SUMMARY

Various implementations of articles, apparatus and methods are described herein to adjust an output light level of a dimmable luminaire, for example a dimmable luminaire that employs light emitting diodes (LEDs) and which is controlled via a dimming line. The various implementations can advantageously eliminate the use of resistors to control the dimming line, and consequently can be compatible with a wide range of dimming line source currents (e.g., from 100 microamperes to 15 milliamperes) and potentially increasing overall efficiency. Such implementations are advantageously interchangeably useable with almost any LED driver and dimming line associated with the LED driver. In addition, at least some implementations employ an “open collector” approach, which further advantageously allows for use with “peripheral” devices, for example for use with low power photocontrols, which can be added in parallel to a disclosed field adjustable output (FAO) controller and associated circuit thereof.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a schematic diagram of a field adjustable output control circuit usable with a luminaire to adjust dimming of solid state light sources thereof, according to at least one illustrated implementation.

FIG. 1B is a schematic diagram of a field adjustable output control circuit usable with a luminaire to adjust dimming of solid state light sources thereof, according to at least another illustrated implementation.

FIG. 2 is a front, bottom, right side isometric view of a field adjustable output control usable with a luminaire to adjust dimming of solid state light sources thereof, the field adjustable output control can include a field adjustable output control circuit, for example the field adjustable output control circuits of FIG. 1A or 1B, according to at least one illustrated implementation.

FIG. 3A is a bottom, front, right side isometric view of a luminaire useable with a field adjustable output control, for example usable with the field adjustable output control of FIG. 2, according to at least one illustrated implementation.

FIG. 3B a top plan view of the luminaire of FIG. 3A, showing an interface to couple a peripheral device or component thereto, for instance to couple a photocontrol thereto, according to at least one illustrated implementation.

FIG. 3C a bottom plan view of the luminaire of FIGS. 3A and 3B with a cover or panel removed to expose a portion of an interior of the luminaire and showing a field adjustable output control of FIG. 2 coupled therein, according to at least one illustrated implementation.

FIG. 4 is a bottom, front left side isometric view of a photocontrol, which can be coupled to the interface of the luminaire of FIGS. 3A-3C, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with luminaires, solid state lights for instance LEDs, drive circuits for instance LED drivers, photocontrols, and/or other peripheral components have not been shown or described in detail to avoid unnecessarily obscuring descriptions of the various implementations and embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one implementation” or “an implementation” or “one embodiment” or “an embodiment” means that a particular feature, structure or characteristic described in connection with the embodiment is included in at least one implementation or embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims, the term “set” refers to a non-zero collection of members or elements.

As used in this specification and the appended claims, the term “node” refers to a point in an electric or electronic circuit. A node, for instance, may refer to a terminal of a circuit element or a point at which two or more terminals of circuit elements are joined.

Technologies described and depicted in the instant disclosure relate to articles, apparatus and methods that are operable to adjust an output light level of a dimmable luminaire, for example a dimmable luminaire that employs solid-state light sources for instance light emitting diodes (LEDs), and which is controlled via a dimming line. The various implementations can advantageously eliminate the use of resistors to control the dimming line, and consequently can be compatible with a wide range of dimming line source currents (e.g., from 100 microamperes to 15 milliamperes). Such implementations are advantageously interchangeably useable with almost any LED driver. At least some implementations employ an “open collector” approach, which further advantageously allows for use with “peripheral” devices, for example use with low power photocontrols. The various described approaches can advantageously be employed to control an amount of illumination, a combined color temperature, and/or a throw pattern using a simple, and reliable circuit that accommodates a wide variety of LED drivers.

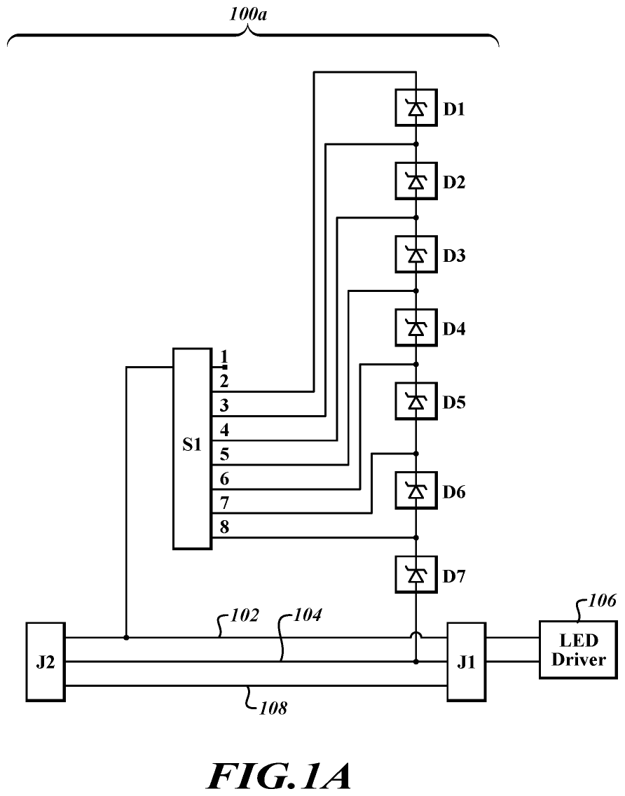

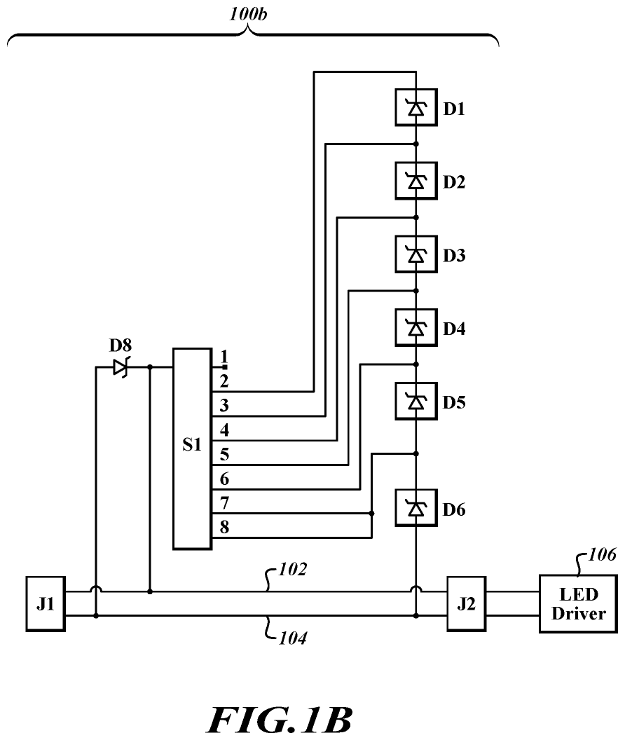

FIG. 1A shows a field adjustable output (FAO) control circuit 100a usable with a luminaire to adjust dimming, according to at least one illustrated implementation.

The FAO control circuit 100a includes a plurality of low current “shunt” type voltage reference integrated circuits D1, D2, D3, D4, D5, D6. The low current “shunt” type voltage reference integrated circuits D1, D2, D3, D4, D5, D6 can each have relatively voltage values, for example voltage values of approximately 1.25 volts. The FAO control circuit 100a includes a voltage reference integrated circuit D7. The voltage reference integrated circuit D7 can have a voltage value that sets a minimum dimming value, for example a minimum dimming value of approximately 2.05 volts. Other voltage values may be chosen to set different dimming values at each switch position.

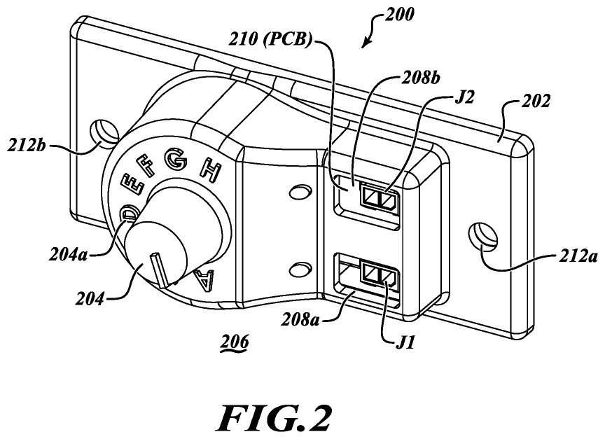

The FAO control circuit 100a includes at least one selector switch S1 which is operable to select a desired or specified dimming level, for example operable to selectively adjust a total number of the plurality of voltage reference integrated circuits electrically coupled in series with one another between an LED driver dimming line and a ground to regulate a flow of current from the LED driver dimming line via a summed voltage that is equal to a sum of voltages respective associated voltage drops across the voltage reference integrated circuits that are electrically coupled in series with one another between the LED driver dimming line and the ground by the at least one switch. The at least one selector switch S1 can take a large variety of forms, for example, the form of a multi-position selector switch (e.g., a mechanical selector for instance a rotary mechanical selector switch or slide switch with multiple orientations, positions or configurations, for instance as illustrated in FIG. 2 and described herein). In at least some implementations, the at least one selector switch S1 has a total number of states equal to an integer value of n and a total number of the plurality of voltage reference integrated circuits is equal to an integer value of n−1.

As an example, if the at least one selector switch S1 is set to a first state or position 1, no voltage reference integrated circuits are coupled between a dimming line 102 (labeled “Violet”) and ground 104, hence the dimming line 102 is not affected, and the LEDs of the associated luminaire not dimmed. Also as an example, if the at least one selector switch S1 is set to an eighth state or position 8, the at least one selector switch S1 electrically couples one voltage reference integrated circuit D7 between the dimming line 102 and ground 104. The voltage reference integrated circuit D7 can be used to establish or set a defined minimum voltage drop, for example having a larger voltage drop (e.g., 2.05 volts) thereacross than a voltage drop (e.g., 1.25) across the other ones of the plurality of voltage reference integrated circuits D1-D6. In this example, if the at least one selector switch S1 is set to an eighth state or position 8, the dimming line voltage becomes 2.05 volts. Also as an example, if the at least one selector switch S1 is set to a seventh position 7, the at least one selector switch S1 electrically couples two voltage reference integrated circuits D6, D7 between the dimming line 102 and ground 1-4. The resulting dimming voltage is the sum of voltage drops across the two voltage reference integrated circuits D6, D7, that is: Vd6+Vd7, which in the illustrated example sums to approximately 2.27 volts. As the at least one selector switch S1 is set to the other states or positions 6, 5, 4, 3, 2, successively more of the voltage reference integrated circuits D5-D1 are electrically coupled in series between the dimming line 102 and ground 104. For instance, in a second state or position 2, the resulting dimming voltage is the sum of voltage drops across the seven voltage reference integrated circuits D1-D7, that is:

Vd1+Vd2+Vd3+Vd4+Vd5+Vd6+Vd7, which in the illustrated example sums to approximately 9.55 volts.

Thus, the current flowing from the LED driver dimming line 102 is regulated to a voltage that is a sum of the voltages of the voltage reference integrated circuits D1-D7 that are selectively coupled into a series connection via the at least one selector switch S1. The very low power consumption of the voltage reference integrated circuits (e.g., 70 microamperes) allows the subject FAO control circuit 100a to advantageously operate at a lowest current output of conventional LED drivers 106 (also illustrated in FIG. 1A).

The voltage reference integrated circuits D1-D7 used in this implementation are low power, temperature stable, devices, for example the TS4061 series from STMicro Corporation, however other integrated circuits may be used.

The FAO control circuit 100a can include a first connector J1 to physically and electrically connect to the dimming line 102, ground 104 and optionally to an auxiliary 12 volt line 108. The FAO control circuit 100a can optionally include a second connector J2 to physically and electrically connect to the dimming line 102, ground 104 and optionally to the auxiliary 12 volt line 108. In at least some implementations (e.g., the illustrated example), the 12 volt line 108 is not used but is present so that other devices may be connected to the first connector J1 or the second connector J2. The use of two connectors J1, J2 in this implementation advantageously allows other devices or components (i.e., auxiliary components) to be coupled to the FAO control circuit 100a. For example, such can advantageously allow a low power photocontrol to be coupled to the FAO control circuit 100a.

The FAO control circuit 100a can use only the dimming line 102 and ground 1-4 without auxiliary power (e.g., via 12 volt line) 108. Such a two-wire configuration is useful for LED drivers which have no auxiliary power supply, and which have only a dimming line 102 and ground 104 available.

FIG. 1B shows a field adjustable output (FAO) control circuit 100b usable with a luminaire to adjust dimming, according to at least one illustrated implementation. The FAO control circuit 100b is similar in some respects to the FAO control circuit 100a (FIG. 1A), and thus similar or even identical components are identified with the same reference numbers in FIGS. 1A and 1B and the accompanying discussion.

In contrast to the field adjustable output (FAO) control circuit 100a (FIG. 1A), the field adjustable output (FAO) control circuit 100b is designed to fit a full dimming range of a specific LED driver. The field adjustable output (FAO) control circuit 100b can include a radio (not shown), which reads the dimming line voltage. The field adjustable output (FAO) control circuit 100b is set such that any voltage over 9v sets the LED driver to 100% and any voltage below around 1 volt sets the output of the LED driver to 0% (LEDs OFF) but keeps the radio ON (powered).

The FAO control circuit 100b includes a plurality of low current “shunt” type voltage reference integrated circuits D1, D2, D3, D4, D5. The low current “shunt” type voltage reference integrated circuits D1, D2, D3, D4, D5 can each have relatively voltage values, for example voltage values of approximately 1.25 volts. The FAO control circuit 100b includes a voltage reference integrated circuit D6. The voltage reference integrated circuit D6 can have a voltage value that sets a minimum dimming value, for example a minimum dimming value of approximately 2.0 volts. Other voltage values may be chosen to set different dimming values at various switch positions.

The FAO control circuit 100b includes at least one selector switch S1 which is operable to select a desired or specified dimming level. The at least one selector switch S1 can take a large variety of forms, for example, the form of a multi-position selector switch (e.g., rotary switch or slide switch with multiple orientations, positions or configurations, for instance as illustrated in FIG. 2 and described herein). As an example, if the at least one selector switch S1 is set to a first state or position 1, no (i.e., zero) voltage reference integrated circuits are coupled between a dimming line 102 (labeled “Violet”) and ground 104, hence the dimming line 102 is not affected, and the LEDs of the associated luminaire not dimmed. Also as an example, if the at least one selector switch S1 is set to either a seventh state or position 7 or an eighth state or position 8, the at least one selector switch S1 electrically couples one voltage reference integrated circuit D6 between the dimming line 102 and ground 104. The voltage reference integrated circuit D6 can be used to establish or set a defined minimum voltage drop, for example having a larger voltage drop (e.g., 2.0 volts) thereacross than a voltage drop (e.g., 1.25) across the other ones of the plurality of voltage reference integrated circuits D1-D5. In this example, if the at least one selector switch S1 is set to the seventh state or position 7 or the eighth state or position 8, the dimming line voltage becomes 2.0 volts. Also as an example, if the at least one selector switch S1 is set to a sixth state or position 6, the at least one selector switch S1 electrically couples two voltage reference integrated circuits D5, D6 between the dimming line 102 and ground 1-4. The resulting dimming voltage is the sum of voltage drops across the two voltage reference integrated circuits D5, D6, that is: Vd5+Vd6, which in the illustrated example sums to approximately 2.25 volts. As the at least one selector switch S1 is set to the other states or positions 5, 4, 3, 2, successively more of the voltage reference integrated circuits D4-D1 are electrically coupled in series between the dimming line 102 and ground 104. For instance, in a second state or position 2, the resulting dimming voltage is the sum of voltage drops across the voltage reference integrated circuits D1-D6, that is: Vd1+Vd2+Vd3+Vd4+Vd5+Vd6, which in the illustrated example sums to approximately 8.25 volts.

Thus, the current flowing from the LED driver dimming line 102 is regulated to a voltage that is a sum of the voltages of the voltage reference integrated circuits D1-D7 that are selectively coupled into a series connection via the at least one selector switch S1. The very low power consumption of the voltage reference integrated circuits (e.g., 70 microamperes) allows the subject FAO control circuit 100b to advantageously operate at a lowest current output of conventional LED drivers 106 (also illustrated in FIG. 1B).

The voltage reference integrated circuits D1-D6 used in this implementation are low power, temperature stable, devices, for example the TS4061 series from STMicro Corporation, however other integrated circuits may be used. For example, D1-D5 can take the form of TS4061AICT-1.25, while D6 can take the form of a different integrated circuit than used for D1-D5 with a different associated voltage drop, for instance an TS4061AICT-2.0.

The FAO control circuit 100b can include a first connector J1 to physically and electrically connect to the dimming line 102, ground 104 and optionally to an auxiliary 12 volt line 108. For example, the first connector J1 can takes the form of a three-wire configuration that electrically couples a dimming line, a ground line, and auxiliary power supply line from the LED driver. The FAO control circuit 100b can optionally include a second connector J2 to physically and electrically connect to the dimming line 102, ground 104 and optionally to the auxiliary 12 volt line 108. In at least some implementations (e.g., the illustrated example), the 12 volt line 108 is not used but is present so that other devices may be connected to the first connector J1 or the second connector J2. The use of two connectors J1, J2 in this implementation advantageously allows other devices or components (i.e., auxiliary components or an accessory or accessories) to be coupled to the FAO control circuit 100b. For example, such can advantageously allow a low power photocontrol to be coupled to the FAO control circuit 100b.

The FAO control circuit 100b can use only the dimming line 102 and ground 1-4 without auxiliary power (e.g., via 12 volt line) 108. Such a two-wire configuration is useful for LED drivers which have no auxiliary power supply, and which have only a dimming line 102 and ground 104 available.

FIG. 2 shows a field adjustable output (FAO) control 200 usable with a luminaire to adjust dimming, according to at least one illustrated implementation.

The FOA control 200 includes a housing 202. The housing 202 can house an FOA control circuit or portion thereof. For example, the housing 202 can have an interior that houses the FAO control circuit 100a, 100b (FIG. 1A or 1B) or a portion thereof.

As previously explained, the FOA control 200 includes a selector switch S1 (FIG. 1A or 1B) that is used to adjust a voltage applied to the dimming line 102 (FIG. 1A or 1B). The selector switch S1 (FIG. 1A or 1B) can be a manually manipulable selector switch (e.g., rotary switch, slide switch) having a plurality of positions or configurations (e.g., orientations) allowing the selector switch S1 (FIG. 1A or 1B) to selectively be placed in any one of a plurality of states. In the illustrated implementation, the FOA control 200 includes a portion in the form of a knob 204 that can be placed (e.g., rotated) into a plurality of positions or configurations, in this example each positon or configuration is denominated by a respective one of the letters A through H which appear on a portion of the housing 202. The knob 204 can bear an indicator or marking 204a to visually represent alignment with a selected one of the positions or configurations as represented by the letters. One of skill will appreciate that other indications can be employed to represent respective positons or configurations, for example integers (e.g., 0-6, 0-7; 0-8, 1-8, 1-9), or some implementations can employ no indications relying on the user to access the different positions or configurations by changes in brightness of light emitting by an associated luminaire.

The housing 202 can have one or more ports 208a, 208b (two shown) sized and positioned to provide access to connectors J1, J2. The two connectors J1, J2 can be carried on a printed circuit board 210 (portion visible through ports 208a, 208b), which can also carry the FAO control circuit 100a, 100b (FIG. 1A or 1B).

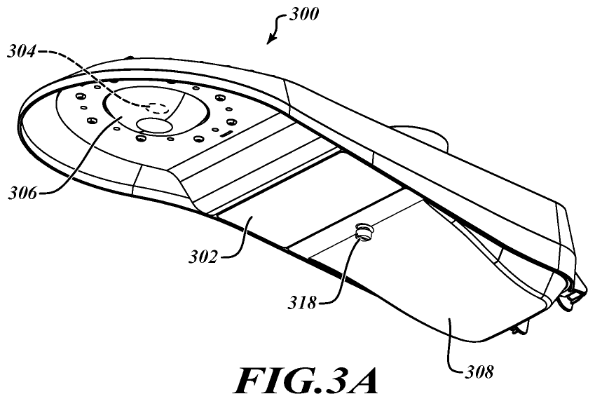

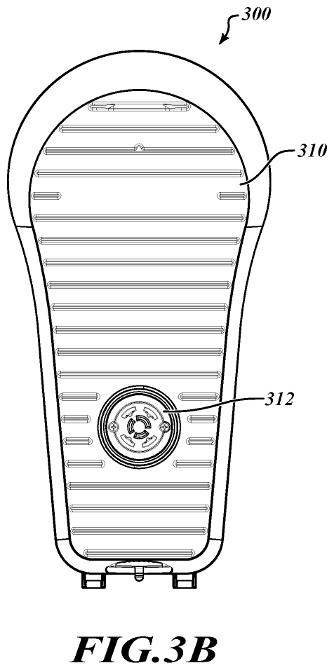

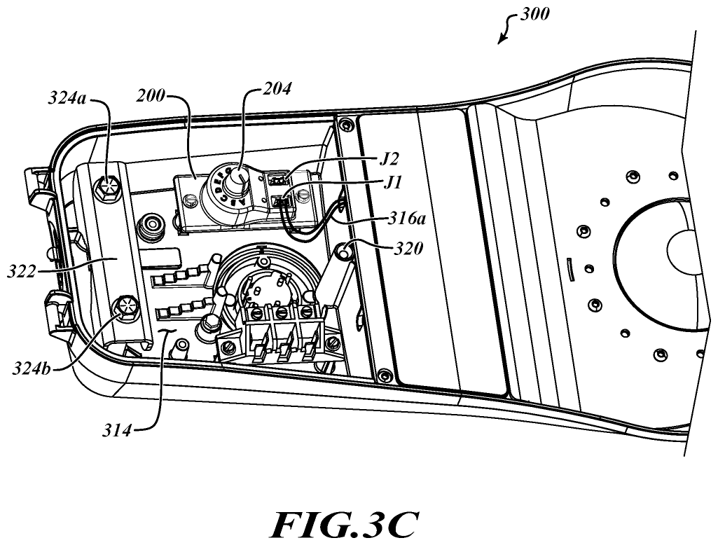

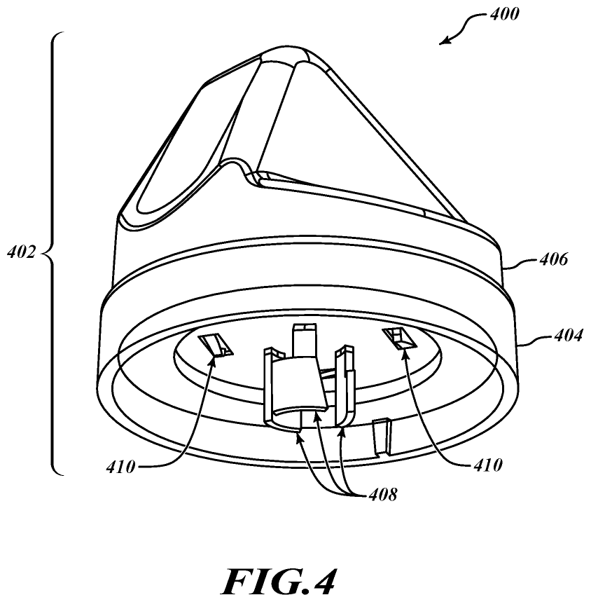

The housing 202 can also have one or more attachment locations or features 212a, 212b (two shown), for example through-holes to receive fasteners (e.g., bolts, screws, clamps). In use, the housing 202 can be physically coupled to a portion of a luminaire, for example physically coupled in an interior of the luminaire or alternatively to an exterior portion thereof. The FAO control circuit 100a, 100b (FIG. 1A or 1B) can be physically and electrically coupled to an LED driver 106 (FIG. 1A or 1B) via one of the connectors (e.g., connector J1) for instance via jumper wires or a jumper cable 316a (FIG. 3C). Optionally, a peripheral device or component (e.g., voltage photocontrol 400, FIG. 4) can be physically and electrically coupled to the FAO control circuit 100a, 100b (FIG. 1A or 1B) for example via one of the connectors (e.g., connector J2) for instance via jumper wires or a jumper cable (not shown) and an interface (interface 312, FIG. 3B).

To select a desired dimming level, the selector knob 204 is rotated align the indicator or marking 204a to the desired position or configuration, thereby coupling none, one, or more of the voltage reference integrated circuits D1-D7 (FIG. 1A or 1B) electrically in series between the dimming line 102 and ground 104 (FIG. 1A or 1B). A desired or suitable position or configuration can, for example, be determined either by choosing the desired lumens of light output (e.g., using a table provided with the FAO control circuit 100a, 100b) or via visual determination of an appropriate light level emitted by an associated luminaire.

The FOA control 200 can be housed in a luminaire, on a luminaire or even on a pole or other support structure for instance a pole or other support structure that supports a luminaire.

FIGS. 3A, 3B and 3C show a luminaire 300, according to at least one illustrated implementation. In particular, FIG. 3A shows a bottom side 302 of the luminaire 300 with a set of solid state light sources in the form of LEDs 304 (only one called out) behind one or more lenses 306, and optionally a removable bottom cover or panel 308. FIG. 3B shows a top portion 310 of the luminaire 300 with a physical and electrical coupler or interface 312 via which a periphery device or component (e.g., a photocontrol) can be physically and electrically coupled. FIG. 3C shows the luminaire 300 with the bottom cover or panel 308 removed, exposing a portion of an interior 314 of the luminaire 300 and illustrating FOA control 200 with knob 204 and connectors J1, J2 along with jumper wires or a jumper cable 316a.

In some implementations, a portion (e.g., knob 204) of the FOA control 200 is manipulable without a tool, for example being sized and shaped to be manually engaged and operated by fingers and/or by a hand of a person. This can advantageously facilitate on-site adjustments of light output of an associated luminaire without the need for tools. In some implementations, the portion (e.g., knob 204) of the FOA control 200 may not be accessible from the exterior 206 of the housing 202 without removal of a cover or panel (e.g., cover or panel 308). Removal of the cover or panel may not require a tool or special tool, for example where secured by detents and provided with a pull or knob, or secured by one or more fasteners 318 (one shown, e.g., nuts, wing nuts, bolts, or clamps) where such fastener(s) 318 are sized and shaped to be manually engaged and operated by fingers and/or by a hand of a person as best illustrated in FIG. 3A where a threaded bolt has a head sized and shaped to be easily grasped and rotated via a thumb and a number of fingers, and a shaft of the threaded bolt is engagingly receivable via a threaded hole 320 (FIG. 3C). Such an approach can be provide adequate security as the luminaires 300 are typically mounted (e.g. pole mounted) sufficiently high enough off the ground as to require a bucket truck to access, hence reducing the likelihood of tampering. Alternatively, removal of the cover or panel 308 may require a special tool (e.g., screw driver or wrench with a non-typical profile) to enhance security. Additionally or alternatively, manipulation of the portion (e.g., knob 204) of the FOA control 200 might be via a tool or special tool, again enhancing security. Alternatively, in some implementations, a portion (e.g., knob 204) of the FOA control 200 is accessible from an exterior 206 of the housing 202 without removal of a cover or panel 308 of the luminaire 300.

As illustrated, the luminaire 300 can include a bracket or clamp 322 with one or more fasteners 324a, 324b (two shown, e.g., nuts, wing nuts, bolts, or clamps) to secure the luminaire 300 to a pole or arm extending from a pole or other support structure.

FIG. 4 shows a photocontrol 400, according to at least one illustrated implementation, the photocontrol physically and electrically coupleable to the luminaire, for instance via the coupler or interface 312 (FIG. 3B).

As illustrated, the photocontrol 400 including a housing 402 comprising a base 404 and a cover 406. The housing 402 houses a set of photocontroller circuitry (not shown). The base 404 of the photocontrol 400 include a set of power contacts 408 and optionally signal contacts 410, accessible from a bottom of the base 404 of housing 402, which can communicatively couple with interface 312 (FIG. 3B), which in turn can be communicatively coupled to the FAO control circuit 100a, 100b via the second connector J2 (FIGS. 1A, 1B, 3C) for example via jumper wires or cables.

The housing 402 may be a clear plastic and may provide environmental protection for the set of photocontroller circuitry and printed circuit board (PCB), as well as protect users from exposure to the set of photocontroller circuitry and possible electrical shock. The housing 402 may include one or more light directing features (not called out in FIG. 4), for example molded into the housing 402. The light directing feature(s) may be included so that the photocontrol is more sensitive in one direction than another.

A rotatable interface (e.g., socket) may be installed in the luminaire 300 (FIGS. 3A-3C) so that the photocontrol 400 may be rotated to a preferred direction, such as the North direction. A secondary light direction element or coating may be inserted or applied to the cover to block or channel ambient light to a photosensor, to increase the directional response of the photocontrol 400. The housing 402 is sealed to the contact mounting base to protect the photocontrol circuitry from water or foreign matter ingress. The housing 402 may be infused with UV protecting chemicals such as the Omnifusion™ process.

The photocontrol 400 can take any of a variety of forms, for example the photocontrol illustrated and described in commonly assigned: U.S. Pat. Nos. 9,445,485; 9,462,662; 9,466,443; 10,531,537; 11,234,304; or U.S. patent application Ser. No. 17/702,654, published as U.S. Patent Application Publication No. 2022-0217827A1. The photocontrol 400 can take the form of a low voltage photocontrol.

The various implementations and embodiments described above can be combined to provide further implementations and embodiments. All of the commonly assigned US patent application publications, US patent applications, foreign patents, and foreign patent applications referred to in this specification and/or listed in the Application Data Sheet, including but not limited to: U.S. Provisional Patent Application No. 61/052,924, filed May 13, 2008; U.S. Pat. No. 8,926,138, issued Jan. 6, 2015; PCT Publication No. WO2009/140141, published Nov. 19, 2009; U.S. Provisional Patent Application No. 61/051,619, filed May 8, 2008; U.S. Pat. No. 8,118,456, issued Feb. 21, 2012; PCT Publication No. WO2009/137696, published Nov. 12, 2009; U.S. Provisional Patent Application No. 61/088,651, filed Aug. 13, 2008; U.S. Pat. No. 8,334,640, issued Dec. 18, 2012; U.S. Provisional Patent Application No. 61/115,438, filed Nov. 17, 2008; U.S. Provisional Patent Application No. 61/154,619, filed Feb. 23, 2009; U.S. Patent Publication No. 2010/0123403, published May 20, 2010; U.S. Patent Publication No. 2016/0021713, published Jan. 21, 2016; PCT Publication No. WO2010/057115, published May 20, 2010; U.S. Provisional Patent Application No. 61/174,913, filed May 1, 2009; U.S. Pat. No. 8,926,139, issued Jan. 6, 2015; PCT Publication No. WO2010/127138, published Nov. 4, 2010; U.S. Provisional Patent Application No. 61/180,017, filed May 20, 2009; U.S. Pat. No. 8,872,964, issued Oct. 28, 2014; U.S. Patent Publication No. 2015/0015716, published Jan. 15, 2015; PCT Publication No. WO2010/135575, published Nov. 25, 2010; U.S. Provisional Patent Application No. 61/229,435, filed Jul. 29, 2009; U.S. Patent Publication No. 2011/0026264, published Feb. 3, 2011; U.S. Provisional Patent Application No. 61/295,519, filed Jan. 15, 2010; U.S. Provisional Patent Application No. 61/406,490, filed Oct. 25, 2010; U.S. Pat. No. 8,378,563, issued Feb. 19, 2013; PCT Publication No. WO2011/088363, published Jul. 21, 2011; U.S. Provisional Patent Application No. 61/333,983, filed May 12, 2010; U.S. Pat. No. 8,541,950, issued Sep. 24, 2013; PCT Publication No. WO2010/135577, published Nov. 25, 2010; U.S. Provisional Patent Application No. 61/346,263, filed May 19, 2010; U.S. Pat. No. 8,508,137, issued Aug. 13, 2013; U.S. Pat. No. 8,810,138, issued Aug. 19, 2014; U.S. Pat. No. 8,987,992, issued Mar. 24, 2015; PCT Publication No. WO2010/135582, published Nov. 25, 2010; U.S. Provisional Patent Application No. 61/357,421, filed Jun. 22, 2010; U.S. Pat. No. 9,241,401, granted Jan. 19, 2016; PCT Publication No. WO2011/163334, published Dec. 29, 2011; U.S. Pat. No. 8,901,825, issued Dec. 2, 2014; U.S. Patent Publication No. 2015/0084520, published Mar. 26, 2015; PCT Publication No. WO2012/142115, published Oct. 18, 2012; U.S. Pat. No. 8,610,358, issued Dec. 17, 2013; U.S. Provisional Patent Application No. 61/527,029, filed Aug. 24, 2011; U.S. Pat. No. 8,629,621, issued Jan. 14, 2014; PCT Publication No. WO2013/028834, published Feb. 28, 2013; U.S. Provisional Patent Application No. 61/534,722, filed Sep. 14, 2011; U.S. Pat. No. 9,312,451, issued Apr. 12, 2016; PCT Publication No. WO2013/040333, published Mar. 21, 2013; U.S. Provisional Patent Application No. 61/567,308, filed Dec. 6, 2011; U.S. Pat. No. 9,360,198, issued Jun. 7, 2016; U.S. Provisional Patent Application No. 61/561,616, filed Nov. 18, 2011; U.S. Patent Publication No. 2013/0141010, published Jun. 6, 2013; PCT Publication No. WO2013/074900, published May 23, 2013; U.S. Provisional Patent Application No. 61/641,781, filed May 2, 2012; U.S. Patent Publication No. 2013/0293112, published Nov. 7, 2013; U.S. Patent Publication No. 2013/0229518, published Sep. 5, 2013; U.S. Provisional Patent Application No. 61/640,963, filed May 1, 2012; U.S. Patent Publication No. 2013/0313982, published Nov. 28, 2013; U.S. Patent Publication No. 2014/0028198, published Jan. 30, 2014; U.S. Pat. No. 9,801,248, issued Oct. 24, 2017; PCT Publication No. WO2014/018773, published Jan. 30, 2014; U.S. Provisional Patent Application No. 61/723,675, filed Nov. 7, 2012; U.S. Pat. No. 9,301,365, issued Mar. 29, 2016; U.S. Provisional Patent Application No. 61/692,619, filed Aug. 23, 2012; U.S. Patent Publication No. 2014/0055990, published Feb. 27, 2014; U.S. Provisional Patent Application No. 61/694,159, filed Aug. 28, 2012; U.S. Pat. No. 8,878,440, issued Nov. 4, 2014; U.S. Patent Publication No. 2014/0062341, published Mar. 6, 2014; U.S. Patent Publication No. 2015/0077019, published Mar. 19, 2015; PCT Publication No. WO2014/039683, published Mar. 13, 2014; U.S. Provisional Patent Application No. 61/728,150, filed Nov. 19, 2012; U.S. Patent Publication No. 2014/0139116, published May 22, 2014; U.S. Pat. No. 9,433,062, issued Aug. 30, 2016; PCT Publication No. WO2014/078854, published May 22, 2014; U.S. Provisional Patent Application No. 61/764,395, filed Feb. 13, 2013; U.S. Pat. No. 9,288,873, issued Mar. 15, 2016; U.S. Provisional Patent Application No. 61/849,841, filed Jul. 24, 2013; U.S. Patent Publication No. 2015/0028693, published Jan. 29, 2015; PCT Publication No. WO2015/013437, published Jan. 29, 2015; U.S. Provisional Patent Application No. 61/878,425, filed Sep. 16, 2013; U.S. Patent Publication No. 2015/0078005, published Mar. 19, 2015; PCT Publication No. WO2015/039120, published Mar. 19, 2015; U.S. Provisional Patent Application No. 61/933,733, filed Jan. 30, 2014; U.S. Pat. No. 9,185,777, issued Nov. 10, 2015; PCT Publication No. WO2015/116812, published Aug. 6, 2015; U.S. Provisional Patent Application No. 61/905,699, filed Nov. 18, 2013; U.S. Pat. No. 9,414,449, issued Aug. 9, 2016; U.S. Pat. Nos. 9,462,662; 9,466,443; 9,781,797, issued Oct. 3, 2017; U.S. Provisional Patent Application No. 62/068,517, filed Oct. 24, 2014; U.S. Provisional Patent Application No. 62/183,505, filed Jun. 23, 2015; U.S. Pat. No. 9,445,485, issued Sep. 13, 2016; PCT Publication No. WO2016/064542, published Apr. 28, 2016; U.S. Provisional Patent Application No. 62/082,463, filed Nov. 20, 2014; U.S. Publication No. 2016/0150369, published May 26, 2016; PCT Publication No. WO2016/081071, published May 26, 2016; U.S. Provisional Patent Application No. 62/057,419, filed Sep. 30, 2014; U.S. Publication No. 2016/0095186, published Mar. 31, 2016; PCT Publication No. WO2016/054085, published Apr. 7, 2016; U.S. Provisional Patent Application No. 62/114,826, filed Feb. 11, 2015; U.S. Non-provisional patent application Ser. No. 14/939,856, filed Nov. 12, 2015; U.S. Provisional Patent Application No. 62/137,666, filed Mar. 24, 2015; U.S. Non-provisional patent application Ser. No. 14/994,569, filed Jan. 13, 2016; U.S. Non-provisional patent application Ser. No. 14/844,944, filed Sep. 3, 2015; U.S. Provisional Patent Application No. 62/208,403, filed Aug. 21, 2015; U.S. Non-provisional Patent Application Ser. No. 15/238,129, filed Aug. 16, 2016; U.S. Provisional Patent Application No. 62/264,694, filed Dec. 8, 2015; U.S. Non-provisional patent application Ser. No. 15/369,559, filed Dec. 5, 2016; U.S. Provisional Patent Application No. 62/397,709, filed Sep. 21, 2016; U.S. Non-provisional patent application Ser. No. 15/709,022, filed Sep. 19, 2017; U.S. Provisional Patent Application No. 62/397,713, filed Sep. 21, 2016; U.S. Non-provisional patent application Ser. No. 15/709,028, filed Sep. 19, 2017; U.S. Provisional Patent Application No. 62/327,939, filed Apr. 26, 2016; U.S. Non-provisional patent application Ser. No. 15/496,985, filed Apr. 25, 2017; U.S. Provisional Patent Application No. 62/379,037, filed Aug. 24, 2016; U.S. Non-provisional patent application Ser. No. 15/681,927, filed Aug. 21, 2017; U.S. Provisional Patent Application No. 62/458,970, filed Feb. 14, 2017; U.S. Non-provisional patent application Ser. No. 15/895,439, filed Feb. 13, 2018; U.S. Provisional Patent Application No. 62/480,833, filed Apr. 3, 2017; U.S. Non-provisional patent application Ser. No. 15/943,183, Apr. 2, 2018; U.S. Provisional Patent Application No. 62/507,730, filed May 17, 2017; U.S. Non-provisional patent application Ser. No. 15/980,978, filed May 16, 2018; U.S. Non-provisional patent application Ser. No. 15/799,744, filed Oct. 31, 2017; U.S. Provisional Patent Application No. 62/669,883, filed May 10, 2018; U.S. Provisional Patent Application No. 62/701,392, filed Jul. 20, 2018; U.S. patent application Ser. No. 16/517,137, filed Jul. 19, 2019 (now published as US2020/0029404); U.S. Provisional Application No. 62/930,283, filed Nov. 4, 2019; U.S. Pat. No. 10,531,537; U.S. patent application Ser. No. 16/842,924, filed Apr. 8, 2020 and now granted as U.S. Pat. No. 11,234,304; U.S. patent application 62/864,121, filed Jun. 20, 2019; U.S. patent application 63/010,412, filed Apr. 15, 2020; U.S. Non-provisional application Ser. No. 16/906,800, filed Jun. 19, 2020; U.S. Non-provisional application Ser. No. 17/088,395, filed Nov. 3, 2020 and granted as U.S. Pat. No. 11,212,887; U.S. patent application Ser. No. 17/702,654, published as U.S. Patent Application Publication No. 2022-0217827A1; and U.S. Provisional Patent Application No. 63/429,675, filed Dec. 2, 2022, are each incorporated herein by reference, in their entirety. These and other changes can be made to the embodiments in light of the above-detailed description.

The various embodiments described above can be combined and/or modified to provide further embodiments in light of the above-detailed description, including the material incorporated by reference. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

I claim:

1. An apparatus, comprising:
a plurality of voltage reference integrated circuits, each of the voltage reference integrated circuits having a respective associated voltage drop thereacross; and
at least one switch operable to selectively adjust a total number of the plurality of voltage reference integrated circuits electrically coupled in series with one another between an LED driver dimming line and a ground to regulate a flow of current from the LED driver dimming line via a summed voltage that is equal to a sum of voltages respective associated voltage drops across the voltage reference integrated circuits that are electrically coupled in series with one another between the LED driver dimming line and the ground by the at least one switch.

2. The apparatus of claim 1 wherein the at least one switch is operable to selectively adjust the total number of the plurality of voltage reference integrated circuits electrically coupled in series with one another between the LED driver dimming line and the ground to be equal to zero.

3. The apparatus of claim 1 wherein the at least one switch has a total number of states equal to an integer value of n and a total number of the plurality of voltage reference integrated circuits is equal to an integer value of n−1.

4. The apparatus of claim 3 wherein for each successive state i from 1 through n, the at least one switch serially couples a number i of the plurality of voltage reference integrated circuits in series with one another between the LED driver dimming line and the ground.

5. The apparatus of claim 1 wherein one of the plurality of voltage reference integrated circuits has a larger voltage drop thereacross than other ones of the plurality of voltage reference integrated circuits and the one of the plurality of voltage reference integrated circuits that has the larger voltage drop sets a minimum voltage drop for the apparatus, and the at least one switch operable in at least one state to couple only the one of the plurality of voltage reference integrated circuits that has the larger voltage drop between the LED driver dimming line and the ground without the other ones of the of the plurality of voltage reference integrated circuits coupled between the LED driver dimming line and the ground.

6. The apparatus of claim 1 wherein the at least one switch is operable to selectively adjust the total number of the plurality of voltage reference integrated circuits electrically coupled in series with one another between the LED driver dimming line and the ground to be an integer number between zero and seven, inclusive of zero and seven.

7. The apparatus of claim 1 wherein the at least one switch is a mechanical selector switch.

8. The apparatus of claim 7 wherein the at least one switch is a rotary mechanical selector switch.

9. The apparatus of claim 1, further comprising:
a housing having an interior and an exterior, the plurality of voltage reference integrated circuits housed in the interior of the housing, and wherein the at least one switch is physically engageable from an exterior of the housing either with or without a tool.

10. The apparatus of claim 1, further comprising:
a housing having an interior and an exterior, the plurality of voltage reference integrated circuits housed in the interior of the housing, and wherein the at least one switch includes a knob that extend into the exterior from the housing and is physically engageable from the exterior of the housing without a tool.

11. The apparatus of claim 1 wherein the at least one switch is operable to set a desired dimming level of a luminaire.

12. The apparatus of claim 1 wherein the plurality of voltage reference integrated circuits are electrically coupleable between the LED driver dimming line and the ground without any resistor therebetween.

13. The apparatus of claim 1, further comprising:
a first connector to mechanically and electrically couple to an LED driver.

14. The apparatus of claim 13 wherein the first connector takes a form of a two-wire configuration that electrically couples only a dimming line and a ground line to the LED driver and does not have any auxiliary power supply line.

15. The apparatus of claim 13 wherein the first connector takes a form of a three-wire configuration that electrically couples a dimming line, a ground line, and auxiliary power supply line from the LED driver.

16. The apparatus of claim 13, further comprising:
a second connector to mechanically and electrically couple to an accessory.

17. The apparatus of claim 16 wherein the accessory is a low power photocontrol.

18. The apparatus of claim 1 wherein the voltage reference integrated circuits are each low power, temperature stable, integrated circuit, with all of the voltage reference integrated circuits mounted on a printed circuit board.

19. The apparatus of claim 1, further comprising:
a plurality of light emitting diodes and wherein the apparatus takes a form of a luminaire.

20. The apparatus of claim 1 wherein the apparatus is physically and electrically coupleable to a luminaire that comprises a plurality of light emitting diodes and the apparatus is operable to adjust an output of the plurality of light emitting diodes of the luminaire.
